(19) United States
(12) Patent Application Publication
(10) Pub. No.: US 2008/0113596 A1
(43) Pub. Date: May 15, 2008

(54) Freshwater Shrimp And Method Of Preparing Same For Packaging, Sale And Consumption

(76) Inventor: Robert Hooey, Medina, WA (US)

Correspondence Address: MANN LAW GROUP, 1420 FIFTH AVENUE, SUITE 2200, SEATTLE, WA, 98101, US

(21) Appl. No.: 11/560,219

(22) Filed: Nov. 15, 2006

(51) Int. Cl. A22C 29/02; A47J 37/00; B65B 25/06

(52) U.S. Cl. 452/3; 426/129; 426/392; 426/523

(57) ABSTRACT

A freshwater shrimp product is provided by cutting the tail portion of the shrimp along the dorsal region thereof to expose the vein for removal. The cut is made to a depth of at least about one-half the thickness of the tail portion. This not only permits easy removal of the vein, but permits the flesh of the tail portion to be spread apart and exposed prior to being individually quick frozen. This facilitates cooking the shrimp by means other than boiling, and makes them particularly well-suited for cooking by means of dry heat, such as grilling or broiling.

### FIELD OF THE INVENTION

This invention relates generally to seafood products and more particularly to freshwater shrimp and methods of preparing them.

### BACKGROUND OF THE INVENTION

Shrimp are a popular seafood item that grow and can be cultivated in both saltwater and freshwater. At present, saltwater shrimp (“Pineas” family) are a more popular seafood item than freshwater shrimp. However, certain advantages in cultivating freshwater shrimp suggest they may also be a commercially viable and successful seafood item.

A principal drawback of using freshwater shrimp, at present, is that they contain a very dark, prominent and noticeable alimentary tract or “vein” that runs along the backside of the shrimp near the shell and just under the surface. Although all shrimp contain such a vein, known techniques in the cultivation and feeding of saltwater shrimp result in a far less prominent and far less noticeable vein than in the case of freshwater shrimp. At present, there are no effective techniques for minimizing or eliminating the prominence of the vein in the freshwater shrimp, and the presence of such a vein in the finished product is unappealing to many consumers, thus limiting the potential commercial value of such freshwater shrimp.

Another drawback of freshwater shrimp is that they do not stand up well to boiling—the most popular way of cooking shrimp. A need thus exists for finding ways of making freshwater shrimp a more viable commercial product than they at present are.

### SUMMARY OF THE INVENTION

The invention provides a method of preparing freshwater shrimp for sale to consumers including the steps of cutting along the dorsal region of the tail portion of the freshwater shrimp to a depth of al least about one-half the thickness of the tail portion to expose the vein of the freshwater shrimp, removing the vein from the tail portion, and individually quick-freezing the shrimp for packaging and sale.

The invention also provides a freshwater shrimp product comprising a freshwater shrimp wherein the dorsal region of the tail portion of the shrimp has been cut to a depth of al least about one-half the thickness of the tail portion to expose the vein of the freshwater shrimp, wherein the vein of the freshwater shrimp has been removed after such cutting, wherein the flesh of the tail portion has been spread apart along the cut to expose substantially the flesh of the tail portion along the cut, and wherein the cut shrimp is individually quick frozen after such cutting, removal of the vein and such spreading for shipment and sale.

### BRIEF DESCRIPTION OF THE DRAWINGS

The features of the present invention that are believed to be novel are set forth with particularity in the appended claims. The invention, together with the further objects and advantages thereof, may best be understood by reference to the following description taken in conjunction with the accompanying drawings, wherein like reference numerals identify like elements and wherein:

FIG. 1 is a perspective view of a freshwater shrimp being prepared in accordance with one step of the method herein described.

FIG. 2 is a perspective view of the freshwater shrimp shown in FIG. 1 being prepared in accordance with another step of the method herein described.

FIG. 3 is a perspective view the freshwater shrimp shown in FIG. 2 being prepared in accordance with another step of the method herein described.

FIG. 4 is a perspective view of the freshwater shrimp shown in FIG. 3 being prepared in accordance with another step of the method herein described.

FIG. 5 is a perspective view of a package containing a plurality of the freshwater after being prepared in accordance with the steps shown in FIGS. 1-4.

### DETAILED DESCRIPTION

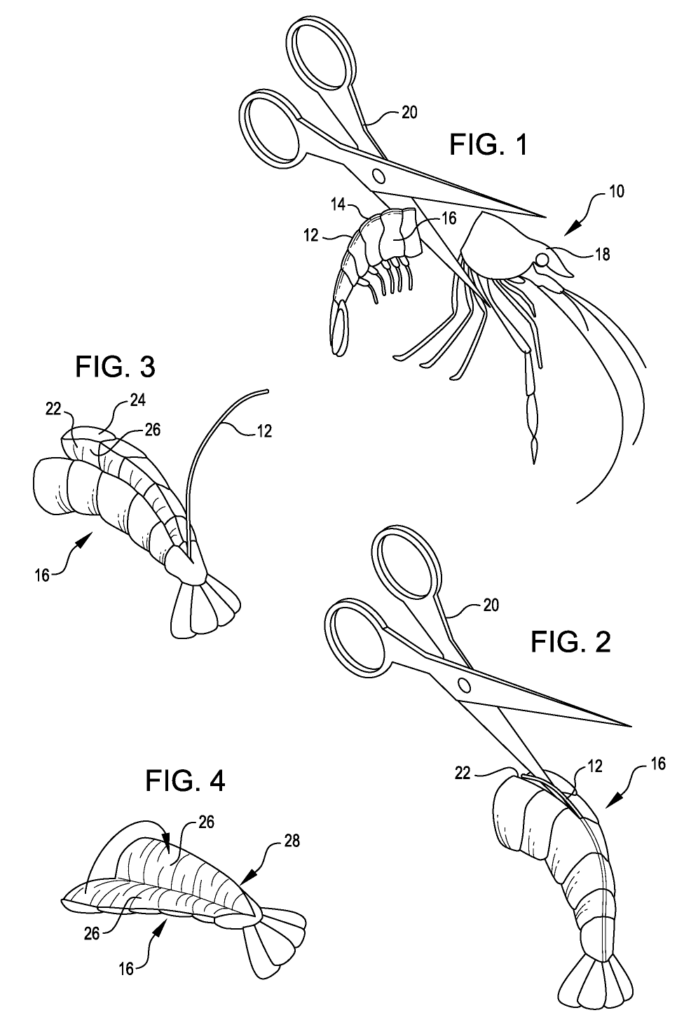

Referring to the drawings and in particular to FIG. 1, a representative freshwater shrimp 10 suitable for use with the invention is shown. The freshwater shrimp is any member of the [scientific name] family and is characterized in that it lives and grows in fresh water. The freshwater shrimp 10 is also characterized in that it typically includes a prominent dark vein 12 extending along the dorsal region 14 of its tail portion 16 as best seen in FIG. 2.

As illustrated in FIG. 1, the freshwater shrimp 10 also includes, in addition to the tail portion 16, a head portion 18. Although not critical to the invention in its broader aspects, the head portion is preferably removed from the freshwater shrimp 10 as part of the process. As further illustrated in FIG. 1, the head portion 18 is preferably separated from the tail portion 16 by hand using a scissors 20 or knife. Alternatively, a mechanized way of accomplishing this end can also be employed.

In accordance with one aspect of the invention, a cut 22 is formed in the tail portion 16 of the shrimp along the dorsal region 14 thereof. Preferably, the cut extends at least about half-way through the thickness of the tail portion 16 through both the shell 24 and flesh 26 of the tail portion 16. In the illustrated embodiment, the cut 22 is formed by hand using the scissors 20. Again, it will be appreciated that other cutting implements and even mechanized techniques can also be employed.

After the cut 22 is formed, the vein 12 is removed along substantially its entire length. The tail portion 16 is then folded outwardly along the cut 22 to expose substantially all the flesh of the tail potion on either side of the cut 22. Although the actual depth of the cut 22 is not critical, it is preferably deep enough that the tail portion can be readily folded outwardly along the cut to substantially separate the sides of the flesh portion contained therein without substantially tearing or otherwise ripping the flesh. In practice, a cut that is between about one-half the thickness of the tail portion and slightly less than the full thickness of the tail portion is advantageous. In all cases, the cut 22 should not extend the full thickness of the tail portion 16 so that the tail portion remains as a single unit 28 rather than two separate halves.

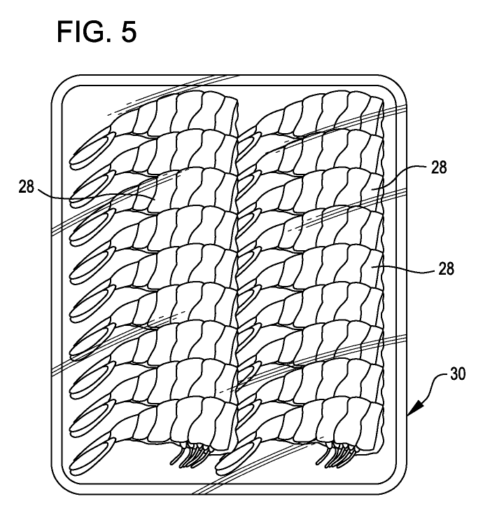

After being processed as shown in FIGS. 1-4, the cut, de-veined and folded-open shrimp 28 are then packaged for shipment and sale. Preferably, the processed shrimp 28 are individually quick-frozen and then packaged for shipment and sale. As shown in FIG. 5, a plurality of the processed shrimp 28 are placed into an individual container 30 that can be sold at retail to consumers. Preferably, a plurality of such containers 30 can then be packed into a larger container (not shown) for import and wholesale sale.

One advantage of processing the freshwater shrimp 10 as shown and described is that the vein 12 is removed before retail sale and before consumption by the ultimate consumer. This results in a more appealing and saleable item than if the vein remained in place. Another advantage of the method of processing freshwater shrimp as herein described is that the shrimp are then rendered particularly well-suited for cooking by means other than boiling. In particular, the deep cut 22 formed along the dorsal region 14 of the shrimp 10 and the subsequent folding out of the shrimp along the cut as seen in FIG. 4 exposes much of the flesh. This, in turn, facilitates cooking the shrimp by means of a dry-heat method such as grilling or broiling—methods that have been found to be better suited to the characteristics of freshwater shrimp over their salt-water counterparts. Preferably, cooking instructions, suggesting dry-heat cooking methods such as grilling and/or broiling can be included in or on the packaging 30 for the shrimp at retail sale.

While a particular embodiment of the invention has been shown and described, it will be apparent to those skilled in the art that changes and modifications can be made without departing from the invention in its broader aspects, and, therefore, the aim in the appended claims is to cover all such changes and modifications as fall within the true spirit and scope of the invention

What is claimed is:

1. A method of preparing freshwater shrimp for sale to consumers comprising the steps of:
cutting along the dorsal region of the tail portion of the freshwater shrimp to a depth of al least about one-half the thickness of the tail portion to expose the vein of the freshwater shrimp;
removing the vein from the tail portion; and
individually quick-freezing the shrimp for packaging and sale.

2. A method as defined in claim 1 comprising the further step of spreading apart the portions of tail on opposite sides of the cut to expose substantially the interior region of the tail portion.

3. A method as defined in claim 2 further comprising the step of separating the head portion of the freshwater shrimp from the tail portion.

4. A method as defined in claim 3 comprising the further step of packaging a plurality of the individually quick frozen shrimp into a single package for shipping and sale.

5. A method as defined in claim 4 further comprising the step of cooking the shrimp by means of exposing the shrimp to dry heat after thawing.

6. A method as defined by claim 5 wherein the dry heat is provided by means of grilling.

7. A method as defined by claim 5 wherein the dry heat is applied by means of broiling.

8. A method as defined by claim 1 wherein the cut formed along the dorsal region of the tail portion of the shrimp extend more than half-way through, but not all the way through, the thickness of the tail portion.

9. A freshwater shrimp product comprising a freshwater shrimp wherein the dorsal region of the tail portion of the shrimp has been cut to a depth of al least about one-half the thickness of the tail portion to expose the vein of the freshwater shrimp, wherein the vein of the freshwater shrimp has been removed after said cutting, wherein the flesh of the tail portion has been spread apart along said cut to expose substantially the flesh of the tail portion along said cut, and wherein the cut shrimp is individually quick frozen after said cutting, removal of said vein and said spreading for shipment and sale.

10. A freshwater shrimp product as defined in claim 9 wherein the head of the freshwater shrimp has been removed.

11. A freshwater shrimp product as defined in claim 10 wherein said cut extends more than about half-way through, but less than all the way through, the thickness of the tail portion of the shrimp.

12. A freshwater shrimp product as defined in claim 11 wherein a plurality of the freshwater shrimp are placed into a single package after being cut, de-veined and frozen.

13. A freshwater shrimp product as defined in claim 12 wherein the freshwater shrimp are packaged along with directions recommending that the freshwater shrimp be cooked by means of dry heat.

14. A freshwater shrimp product as defined in claim 13 wherein the recommended dry heat is grilling.

15. A freshwater shrimp product as defined in claim 13 wherein the recommended dry heat is broiling.
